(19) United States
(12) Patent Application Publication
(10) Pub. No.: US 2008/0294298 A1
(43) Pub. Date: Nov. 27, 2008

(54) Automatic transportation apparatus of characteristic value measurement sensor unit of video appliance and transportation method of the same

(75) Inventor: Ik Soo Park, Seoul (KR)

Correspondence Address: LADAS & PARRY LLP, 26 WEST 61ST STREET, NEW YORK, NY, 10023, US

(73) Assignee: DOOYANG SYSTEMS INC.

(21) Appl. No.: 12/079,704

(22) Filed: Mar. 28, 2008

Related U.S. Application Data
(63) Continuation-in-part of application No. 11/977,649, filed on Oct. 25, 2007.

(30) Foreign Application Priority Data
Apr. 11, 2007 (KR) 10-2007-35500
Oct. 12, 2007 (KR) 10-2007-102867
Mar. 10, 2008 (KR) 10-2008-22153

(51) Int. Cl. G05D 3/00

(52) U.S. Cl. 700/302

(57) ABSTRACT

In an automatic transportation apparatus of a measurement sensor unit for measuring a characteristic value of a video appliance, there is provided an automatic transportation apparatus of a characteristic value measurement sensor unit of a video appliance which comprises a driving force unit which has a driving motor engaged with a spur gear at one side of the same; a transportation unit which is installed at one side of the video appliance and allows the measurement sensor unit engaged to one side to be connected with the spur gear when measuring a characteristic value of the video appliance and to be positioned at the center of the screen of the video appliance and to return to its original position after the measurement is finished; and a controller unit which controls the driving force unit.

### TECHNICAL FIELD

The present invention relates to an automatic transportation apparatus of a characteristic value measurement sensor unit of a video appliance and a transportation method of the same, and in particular to an automatic transportation apparatus of a characteristic value measurement sensor unit of a video appliance, and a transportation method of the same in which a measurement sensor unit is installed at one side of a monitor for measuring a characteristic value of a video appliance, and a measurement sensor unit is automatically transported to the center of a screen when measuring a characteristic value of a video appliance, and a measurement sensor unit returns to its original position and is stored when a corresponding measurement is finished.

### BACKGROUND ART

In recent years, among various video appliances, a monitor, which is equipped with a LCD (Liquid Crystal Display), is widely used in a personal computer or an office computer. The video appliance using a LCD has a few weak points which reside in a color expression or a gradation expression as compared to a video appliance equipped with a CRT (Cathode-ray Tube). The characteristic values of the video appliance may change depending on each manufacturer of a corresponding video appliance. In addition, the characteristic values of a video appliance change as well depending on the date and time of its manufacture even in case of the same products. The characteristic values of a video appliance, which adapts a CRT, gradually change even depending on an aging time of a corresponding part.

With the above different characteristic values of the video appliance, a color feeling, a concentration difference, etc. may be different when expressing a digital photo, an image, etc. on a screen, so a plurality of users may differently feel even with respect to the same digital photos and images. So, in order to make the users feel the same colors, a corresponding video appliance is provided with a certain member, which is able to directly adjust the characteristic values such as color temperature, gamma, contrast, brightness or something. Since the method for adjusting the characteristic value of the video appliance by directly adjusting the above element requires the characteristic values of the video appliance and requires a change in the characteristic value related to the adjustment of each element, the above method should be performed by an expert who has a long time experience or a professional experience.

In easier and simpler methods, the characteristic values of a video appliance can be directly measured by using an additional external apparatus, and the characteristic value of the video appliance can be corrected based on the measured characteristic values of the video appliance.

For examples, in the U.S. Pat. No. 6,163,377 of colormeter, a shell including a photo detector at a light source side is provided with rubber suction cups, so the characteristic values of the video appliance can be measured in a state that the colormeter is temporarily attached to a screen with the help of the rubber suction cups.

In the equipment generally used in a professional business, a certain standard, which satisfies a certain characteristic value in a video appliance and exceeds a certain level, is prepared, and the quality certification with respect to certain professional equipment is performed based on the above standard. For example, the display device used in the medical equipment requires a certain characteristic value in a video appliance by recommending a GSDF (Grayscale Standard Display Function) in the DICOM (Digital Imaging and communication in Medicine) Part 14. So, the video appliance generally used in the medical equipment is provided with a certain correction program for correcting the difference of the characteristic values of a video appliance based on the DICOM GSDF and a measuring device of a characteristic value of a video appliance, respectively.

As shown in FIG. 1, in the apparatus for measuring a characteristic value of a video appliance, a user fixes a sensor unit at the center target point of the screen of a video appliance and measures a light source of a screen. Since a measurement of a characteristic value might be unstably performed when there is a slight motion while the characteristic value of a video appliance is being measured, the measurement apparatus is stably fixed by using a certain fixing member or a support.

For example, as shown in FIG. 2, the monitor calibrator 10 is stably fixed on a screen by using the suction cups 13 engaged to three supporting elements 12 extended from the support structure 11.

In the conventional method for fixing a characteristic value measuring apparatus of a video appliance by using the suction cups, the measuring sensor unit may fall down by means of the weight of the measurement sensor unit. In case of the LCD, it is impossible to maintain a certain space between a color filter glass of a LCD and a TFT glass of a lower plate, which processes a signal, due to the pressurization of the suction cups, so a screen display may have a certain problem.

So, an additional support is preferably used for most closely approaching a sensor unit to the screen, while not directly contacting with the screen of a video appliance and while effectively blocking an external light source. However, in this case, it takes a lot of time to additionally install support members, and sometime a certain space is further needed for installing the support in a limited space.

### DISCLOSURE OF THE INVENTION

Accordingly, it is an object of the present invention to provide an automatic transportation apparatus of a characteristic value measurement sensor unit of a video appliance, and a transportation method of the same which overcome the problems found in the conventional art.

It is another object of the present invention to provide an automatic transportation apparatus of a characteristic value measurement sensor unit of a video appliance and a transportation method of the same in which it is possible to more easily measure a characteristic value of a video appliance by automatically and most closely approaching a characteristic value measurement sensor unit to a screen of a video appliance for measuring the characteristic value of a video appliance, and the characteristic value measurement sensor unit returns to its original position after measurement is finished.

To achieve the above objects, in an automatic transportation apparatus of a measurement sensor unit for measuring a characteristic value of a video appliance, there is provided an automatic transportation apparatus of a characteristic value measurement sensor unit of a video appliance which comprises a driving force unit which has a driving motor engaged with a spur gear at one side of the same; a transportation unit which is installed at one side of the video appliance and allows the measurement sensor unit engaged to one side to be connected with the spur gear when measuring a characteristic value of the video appliance and to be positioned at the center of the screen of the video appliance and to return to its original position after the measurement is finished; and a controller unit which controls the driving force unit.

### EFFECTS OF THE INVENTION

According to an automatic transportation apparatus of a characteristic value measurement sensor unit of a video appliance and a transportation method of the same, it should be appreciated that it is possible to accurately measure the characteristic value of a video appliance unless a user additionally installs a support when measuring the characteristic value of a video appliance by closely approaching a characteristic value measurement sensor unit to a screen of a video appliance, so the measurement of the characteristic value of a video appliance can be performed easily and accurately.

It should be appreciated that when a user inputs a measurement start instruction for measuring the characteristic value of a video appliance, a measurement sensor unit is automatically installed for measuring the characteristic value of a video appliance, and when the measurement is finished, it automatically returns to its original position.

It should be appreciated that the characteristic value of a video appliance can be repeatedly measured by installing the measurement sensor unit in a conventional video appliance one time.

### BRIEF DESCRIPTION OF THE DRAWINGS

The present invention will become better understood with reference to the accompanying drawings which are given only by way of illustration and thus are not limitative of the present invention, wherein;

FIG. 1 is a photo illustrating a method for measuring a characteristic value of a conventional video appliance;

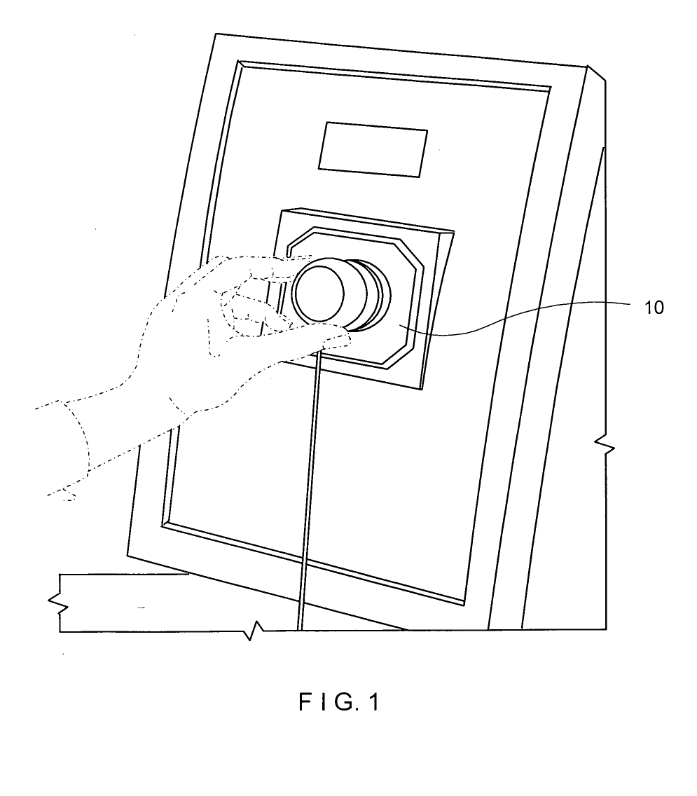

FIG. 2 is a view illustrating an apparatus for measuring a characteristic value of another conventional video appliance;

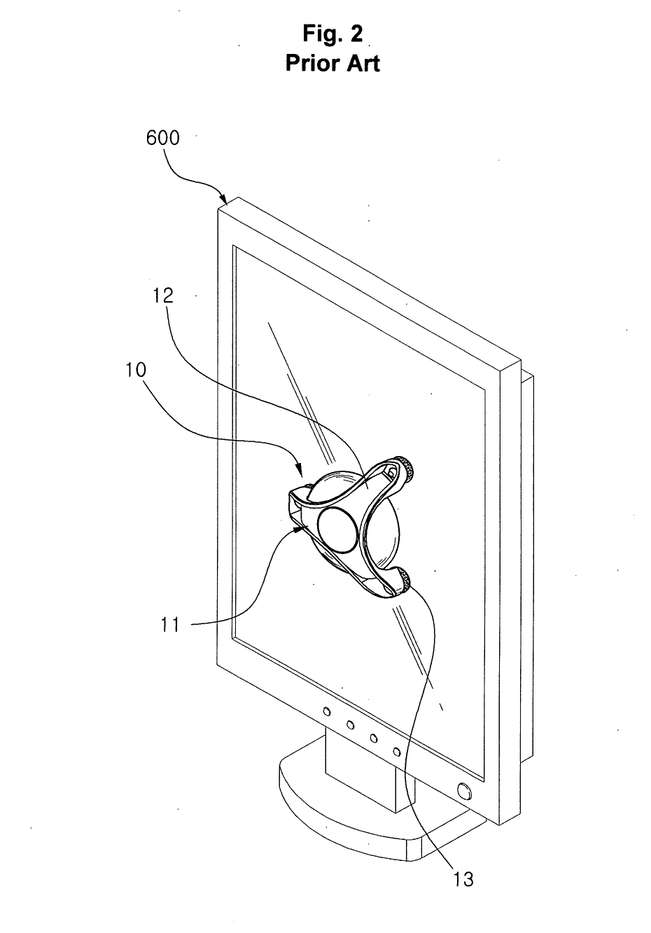

FIG. 3 is a perspective view illustrating an automatic transportation apparatus of a characteristic value measurement sensor unit of a video appliance according to an embodiment of the present invention;

FIG. 4 is a disassembled perspective view illustrating an automatic transportation apparatus of a characteristic value measurement sensor unit of a video appliance of FIG. 3;

FIG. 5 is a view illustrating a use state of an automatic transportation apparatus of a characteristic value measurement sensor unit of a video appliance of FIG. 3;

FIG. 6 is a view illustrating another use stare of an automatic transportation apparatus of a characteristic value measurement sensor unit of a video appliance of FIG. 3;

FIG. 7 is a view illustrating a use state of an automatic transportation apparatus of a characteristic value measurement sensor unit of a video appliance according to another embodiment of the present invention;

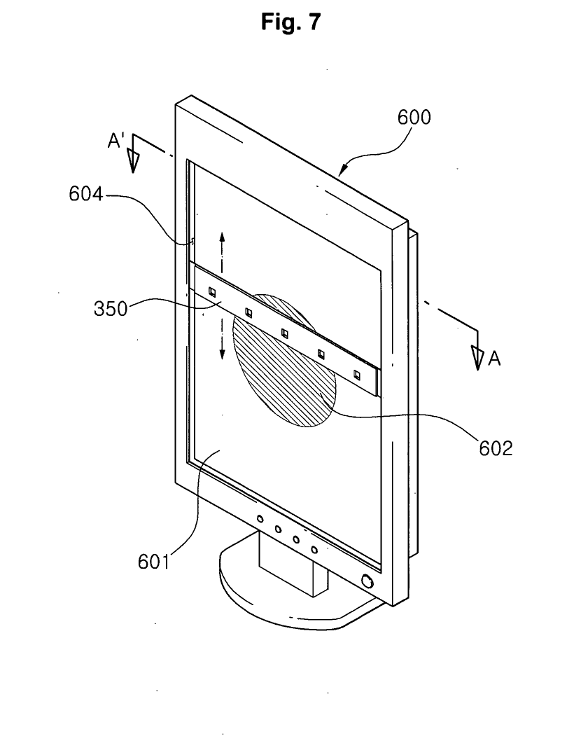

FIG. 8 is a perspective view illustrating a backside of an automatic transportation apparatus of a characteristic value measurement sensor unit of a video appliance used in the embodiment of FIG. 7;

FIG. 9 is a perspective view illustrating a transportation bracket adapted in an automatic transportation apparatus of a characteristic value measurement sensor unit of a video appliance shown in FIG. 8;

FIG. 10 is a plane view illustrating an automatic transportation apparatus of a characteristic value measurement sensor unit of a video appliance shown in FIG. 8;

FIG. 11 is a backside view illustrating an automatic transportation apparatus of a characteristic value measurement sensor unit of a video appliance shown in FIG. 8;

FIG. 12 is a flow chart of an automatic transportation method of a characteristic value measurement sensor unit of a video appliance according to an embodiment of the present invention;

FIG. 13 is a perspective view illustrating an automatic transportation apparatus of a characteristic value measurement sensor unit of a video appliance according to further another embodiment of the present invention; and

FIG. 14 is a view illustrating a use state of an automatic transportation apparatus of a characteristic value measurement sensor unit of a video appliance shown in FIG. 13.

### MODES FOR CARRYING OUT THE INVENTION

The construction and operation of the automatic transportation apparatus of a sensor unit for measuring the characteristic value of a video appliance according to the present invention will be described.

In the following descriptions, the same elements are given the same reference numerals, and in the drawings, the reference character P represents a screen and an operation apparatus for driving the same.

The automatic transportation apparatus 1 for measuring the characteristic value of a video appliance according to the present invention comprises a measurement sensor unit 100 for measuring the characteristic value of a video appliance, transportation units 200 and 300 for transporting the measurement sensor unit 100 of the video appliance to the center of a screen, a driving force unit 400 for driving the transportation units 200 and 300, and a controller 500 provided for an automatic operation of the system by determining the operation timing and direction of the driving force unit 400.

The measurement sensor unit 100 is provided with a sensor for measuring a light source of the screen 601 of the video appliance 601. The measurement sensor unit 100 is positioned at one side of the video appliance 600 and is transported to a target point 602 formed near the center of the screen 601 of the video appliance when measuring the characteristic value of the video appliance for thereby measuring the light source of the screen 601.

The transportation units 200 and 300 are elements for transporting the measurement sensor unit 100 from one side of the video appliance to the target point 602 positioned near the center of the screen.

The driving force unit 400 comprises a motor 401 for adjusting a rotation direction, and a spur gear 402 which is engaged to a rotary shaft of the motor 401. At this time, the measurement sensor unit 100 is transported to the center of the screen 601 or returns to one side of the video appliance 600 by means of the transportation units 200 and 300 depending on the rotation direction of the motor 401.

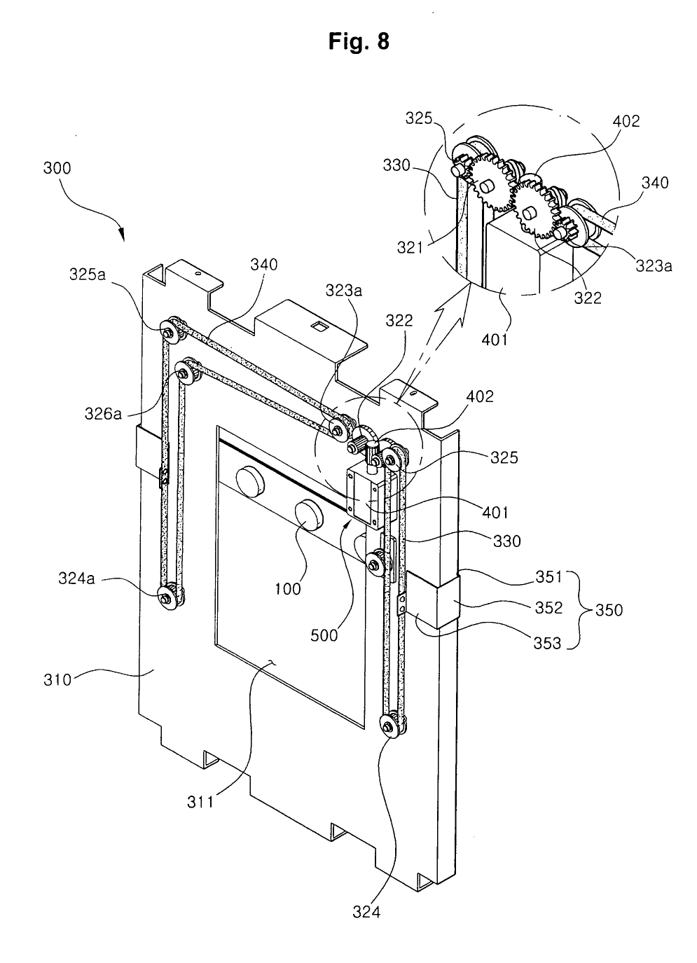

The controller unit 500 recognizes a correction start instruction from an external computer or a controller of the video appliance and allows the measurement sensor unit 100 to move to the target point 602 of the screen 601, and measures the characteristic value and allows the measurement sensor unit 100 to return to its original position. As shown in FIG. 8, the controller unit 500 may be internally installed in the motor or may be externally installed.

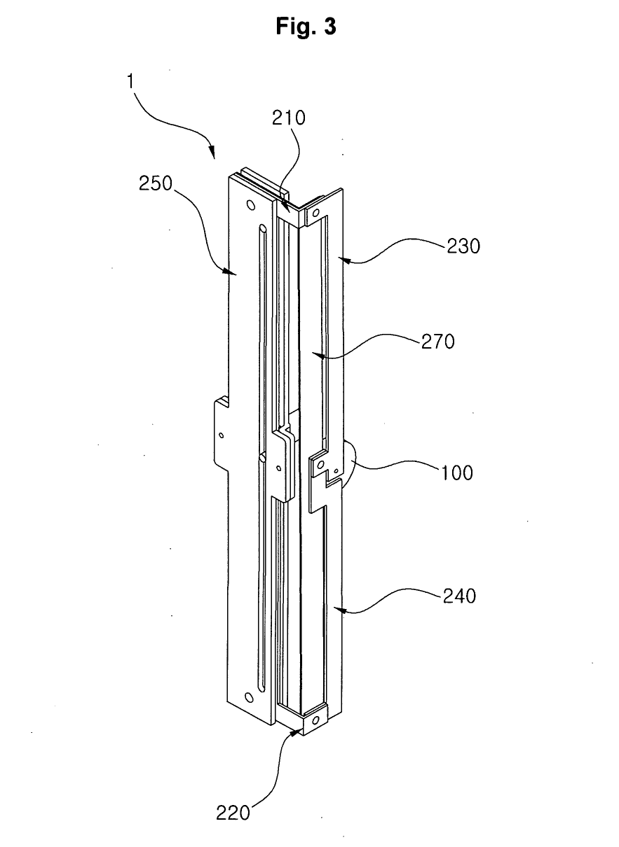

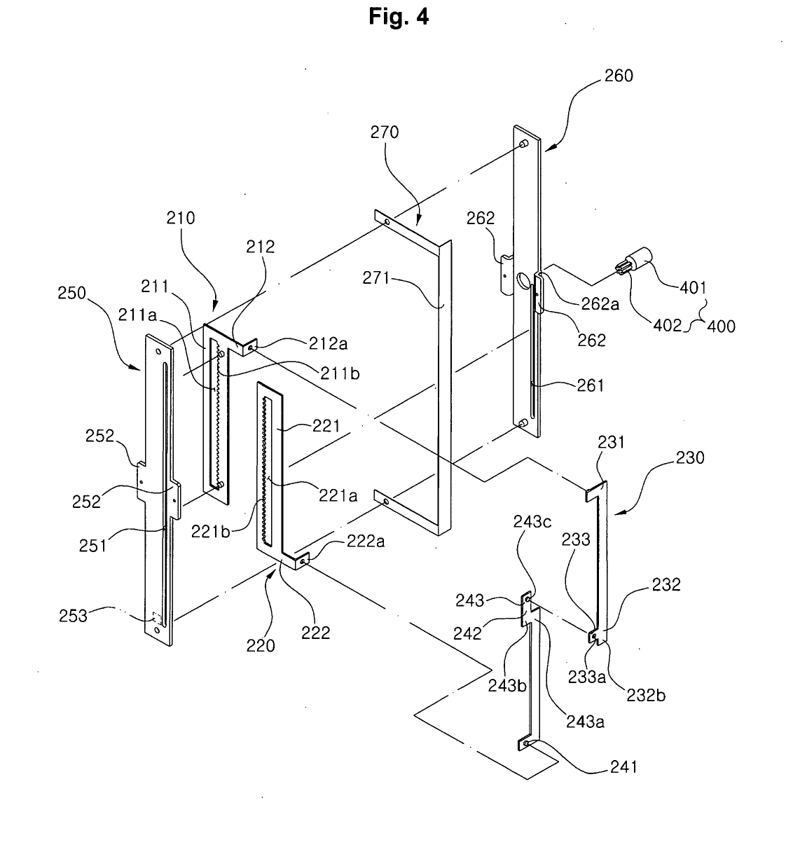

The transportation unit of FIGS. 3 and 4 will be described.

The transportation unit 200 according to a preferred embodiment of the present invention comprises first and second guide brackets 210 and 220, and first and second rotation brackets 230 and 240.

The first guide bracket 210 comprises a first transportation piece 211, and a first engaging piece 212 extended from one side of the first transportation piece 211.

The first transportation piece 211 is formed in a plate shape with the length half of the lateral length of the video appliance 600 and includes a first transportation groove 211a in which a spur gear 402 is engaged in its inner side along a longitudinal direction of the side of the video appliance 600. A rack gear 211b, which is tooth-engaged with the spur gear 402, is formed in one surface of the first transportation groove 211a in a longitudinal direction of the same. The rack gear 211b is engaged with the spur gear 402. So, when the first guide bracket 210 is positioned at a lateral side of the video appliance 600, the first guide bracket 210 is transported in the up and down directions at the lateral side of the video appliance 600.

The first engaging piece 212 is extended from the first transportation piece 211 in the direction of the screen of the video appliance, with its end 212a being bent toward the center of the screen 601. The first rotation bracket 230 is rotatably engaged at the end 212a of the first engaging piece 212.

The second guide bracket 220 comprises a second transportation piece 221, and a second engaging piece 222. The first and second transportation pieces 211 and 221 are slidable in the first guide bracket 210.

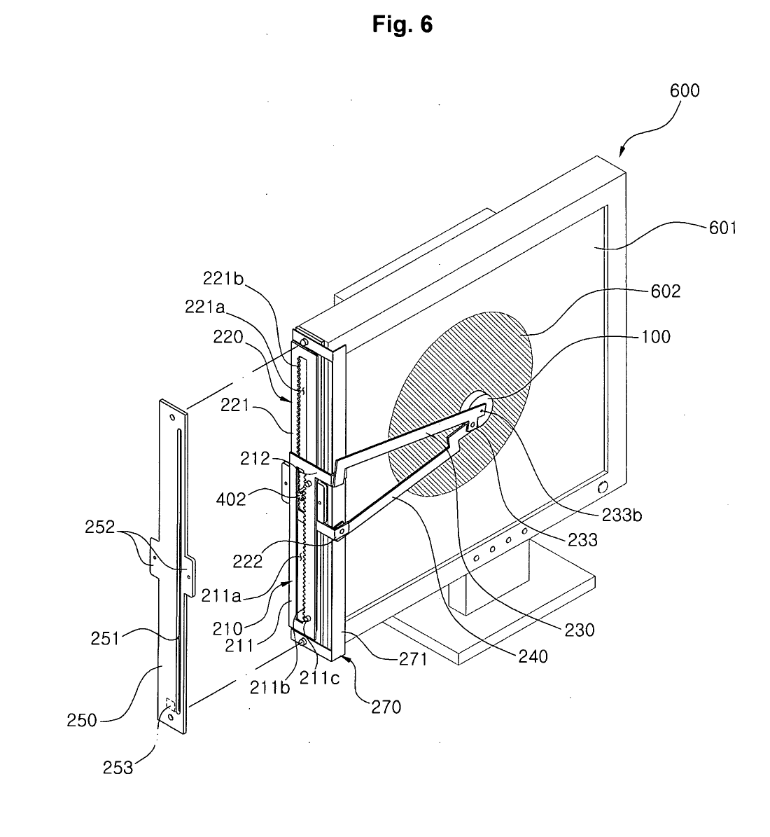

A second transportation groove 221a is formed in the second transportation piece 221, with the spur gear 402 being engaged in an inner side of the second transportation groove 221a. The position and shape of the second transportation groove 221a are similar with the first transportation groove 211a, but the formation position of the rack gear 221b is formed in an inner surface opposite to the position in which the rack gear of the first transportation groove 211a is formed. As shown in FIG. 6, the rack gear 211b of the first transportation groove 211a is formed in an inner surface spaced apart from the screen, whereas the rack gear 221b of the second transportation groove 221a is formed in an inner surface near the screen.

In a state that the second transportation groove 221a and the first transportation groove 211a are overlapped, the spur gear 402 passes through the first and second transportation grooves 211a and 221a and is engaged with the rack gears 211b and 221b, respectively. Namely, the rack gear 211b of the first transportation groove 211a is tooth-engaged with one surface of the spur gear 402, and the rack gear 221b of the second transportation groove 221a is tooth-engaged with the other surface of the same, so the first and second guide brackets 210 and 220 are transported in opposite directions depending on the rotation of the spur gear 402.

The second engaging piece 222 is extended in the direction of the screen of the video appliance in the second transportation piece 221 at the position opposite to the first engaging piece 212, and the end 222a is bent in the direction of the screen. The second rotation bracket 240 is engaged to the end 222a of the second engaging piece 222.

One end of the first rotation bracket 230 is rotatably engaged to the first engaging piece 212, and one end 241 of the second rotation bracket 240 is rotatably engaged to the second engaging piece 222. The other ends 232 and 242 of the first and second rotation brackets 230 and 240 are rotatably engaged with each other, and the measurement sensor unit 100 is engaged to the other ends 232 and 242, respectively.

The first and second rotation brackets 230 and 240 are spaced apart in straight parallel from the first and second guide brackets 210 and 220 in a state that the first and second guide brackets 210 and 220 are spaced apart from each other. In a state that the first and second guide brackets 210 and 220 are close from each other, the engaged portions of the first and second rotation brackets 230 and 240 are bent in the direction of the center of the screen 601 in a protruded shape. The measurement sensor unit 100 of the engaged portions of the first and second rotation brackets 230 and 240 is transported toward the center of the screen 601 depending on the sliding transportation of the first and second guide brackets 210 and 220 or returns to the side surface of the video appliance 600.

The first and second cover brackets 250 and 260 of the transportation unit 200 of FIGS. 3 and 4 will be described.

The first and second cover brackets 250 and 260 are engaged to the outer sides of the first and second guide brackets 210 and 220 for thereby preventing the escapes of the first and second guide brackets 210 and 220. When the transportation unit 200 is additionally installed at the outer side of the conventional video appliance 600, the first and second cover brackets 250 and 260 may be used for fixing the first and second guide brackets 210 and 220 on the side surface of the video appliance 600 while restricting the transportation directions of the first and second guide brackets 210 and 220.

The first cover bracket 250 contacts with the first guide bracket 210, and the second cover bracket 260 contacts with the second guide bracket 220, and the first and second cover brackets 250 and 260 are fixed to each other for thereby operating as the casing of the first and second guide brackets 210 and 220.

At this time, the protrusion 211c is longitudinally protruded from the both sides of the first transportation piece 211 in parallel with respect to the transportation direction. A first guide groove 251 is formed in the first cover bracket 250 in the portion opposite to the protrusion 211c, with the protrusion 211c being slidably engaged to the first guide groove 251.

When the protrusion 211c is longitudinally formed at the both sides of the first transportation piece 211, since the movement range of the protrusion 211c is limited by means of the first guide groove 251, so the length and formation position of the first guide groove 251 limits the transportation distance of the first guide bracket 210.

The second guide groove 261 is formed in the second cover bracket 260, with the protrusion protruded from the second transportation piece 221 being slidably engaged to the second guide groove 261. The second guide groove 261 limits the transportation distance of the first guide groove 251.

First and second auxiliary engaging surfaces 252 and 262 are formed at the centers of the both longitudinal sides of the first and second cover brackets 250 and 260 and are extended for engaging the first and second brackets 250 and 260. The second auxiliary engaging surface 262 can be bent toward the first auxiliary engaging surface 252. At this time, the first and second guide brackets 210 and 220 slide in the inner space formed as the first and second cover brackets 250 and 260 are engaged along their bent lengths. While the first and second engaging pieces 212 and 222 are moving inwardly, the first and second engaging pieces 212 and 222 are supported by means of the bent portion 262a of the second auxiliary engaging surface 262, respectively, the transportation distances of the first and second guide brackets 210 and 220 are limited as well.

The pad bracket of FIG. 4 will be described.

The pad bracket 270 is selectively engaged to the inner surface of the first cover bracket 250 or the second cover bracket 260 and is extended toward the first and second engaging pieces 212 and 222, and one end of the pad bracket 270 is bent toward the screen and becomes a support piece 271.

Here, the engaging position of the pad bracket 270 is determined depending on the bent directions of the first and second engaging pieces 212 and 222. When the first and second engaging pieces 212 and 222 are bent toward the first cover bracket 250, the pad bracket 270 is engaged to an inner side of the first cover bracket 250, and when the first and second engaging pieces 212 and 222 are bent toward the second cover bracket 260, it is engaged to an inner side of the second cover bracket 260.

The support piece 271 is positioned just below the bent portions of the first and second engaging pieces 212 and 222, so it prevents the first and second engaging pieces 212 and 222 from contacting with an outer side of the video appliance 600 when the first and second engaging pieces 212 and 222 are transported.

The engaging structures of the first and second rotation brackets of FIG. 4 will be described.

The first and second rotation brackets 230 and 240 are rotatably engaged with each other, and the measurement sensor unit 100 is engaged at the engaged portions of the same. So, the measurement sensor unit 100 can be stably fixed, and the engaged portions of the first and second rotation brackets 230 and 240 can smoothly rotate.

A first engaging surface 233 extended toward the first guide bracket 210 is formed at a longitudinal end of the first rotation bracket 230, and a through hole 233a is formed in the first engaging surface 233.

A longitudinal end of the second rotation bracket 240 is first bent (243a) toward the first guide bracket 210 for an engagement in the first engaging surface 233 in parallel with respect to the transportation direction of the first guide bracket 210 and is second bent (234b) toward the first engaging surface 233 for thereby forming a second engaging surface 243 overlapped with the first engaging surface 233.

The engagements of the first and second engaging surfaces 233 and 243 are achieved as the protrusion 243c inserted into the through hole 233a of the first engaging surface 233 is formed in the second engaging surface 243 or as a through hole is formed in the second engaging surface, so they can be rotatably engaged by using screws or something.

A measurement sensor unit 100 is stably engaged at the end 233b of the first rotation bracket 230.

The operation of the transportation unit 200 according to an embodiment of the present invention will be described.

When the characteristic value of a video appliance is not measured, the first and second engaging pieces 212 and 222 are spaced apart from each other, so the first and second rotation brackets 230 and 240 remain unfolded in a straight shape or the like. The measurement sensor unit 100 fixed at the engaged portions of the first and second rotation brackets 230 and 240 is positioned at one side of the video appliance while not covering the screen 601 of the video appliance.

When the motor 401 of the driving force unit 400 is driven so as to measure the characteristic value of the video appliance, the spur gear 402 rotates, and the first and second guide brackets 210 and 210 slide in the direction that the first and second engaging pieces 212 and 222 of the first and second guide brackets 210 and 220 become closer by means of the rack gears 211b and 221b engaged to the spur gear 402. As the first and second engaging pieces 212 and 222 come closer with each other, the engaged portions of the first and second rotation brackets 230 and 240 are bent, and the measurement sensor unit 100 fixed at the engaged portions is transported to the center of the screen 601.

When the measurement of the characteristic value of the video appliance is finished, the rotation direction of the motor 401 is reversed, and the measurement sensor unit 100 returns to its original position.

When the first and second cover brackets 250 and 260 are provided, the transportation distances of the first and second guide brackets 210 and 220 are limited by means of the inwardly bent portion of the second auxiliary engaging surface 262 and the first and second guide grooves 251 and 261.

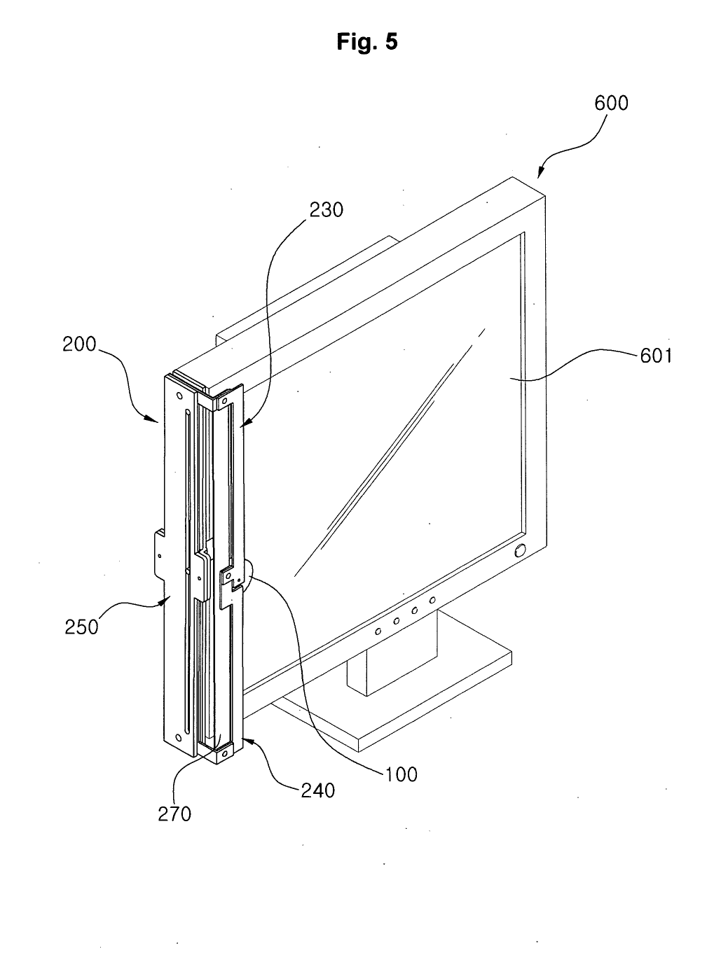

The position recognition sensor of FIGS. 5 and 6 will be described.

The position recognition sensor 253 is fixed at the first guide groove 251 or the second guide groove 261 for thereby recognizing the movement of the first transportation piece 211 or the second transportation piece 221. For the position recognition sensor 253, a photo sensor may be used. The position recognition sensor 253 is provided at one side of the first guide groove 251 and recognizes the position of the first transportation piece 211 or the second transportation piece 221 in a state that the first and second engaging pieces 212 and 222 come closer (this state represents that the measurement sensor unit is positioned near the center of the screen) when the first and second guide brackets 210 and 220 are transported in the direction that the first and second engaging pieces 212 and 222 come closer to each other.

In this case, it is possible to adjust the distance between the first and second engaging pieces 212 and 222 by using the position recognition sensor 253. The above operation can be used when determining a stopping position (data) in the automatic transportation method of a characteristic value measurement sensor unit of a video appliance which will be described later.

The transportation units 300 and 300′ of FIGS. 8 through 11 will be described.

The transportation unit 300 according to another embodiment of the present invention comprises a main bracket 310 positioned behind the screen 601, a driving force transfer unit 320, first and second belts 330 and 340, and a transportation bracket 350.

The main bracket 310 is formed in a flat plate shape and is engaged with the driving force unit 400 and the driving force transfer unit 320.

The driving force transfer unit 320 is engaged with a worm gear 321 tooth-engaged with the spur gear 402 of the driving force unit 400, first and second main pulleys 323 and 323a, first and second cooperation pulleys 324 and 324a, and a direction adjusting gears 322.

The worm gear 321 changes the installation direction of a rotary shaft of the spur gear 402 vertically with respect to the main bracket 310. The worm gear 321 is engaged with the first main pulley 323. A direction adjusting gear 322 is disposed between the second main pulley 323a and the worm gear 321 for reversely changing the rotation directions of the first and second main pulleys 323 and 323a.

Here, a cylindrical work gear structure is formed on an upper side of the worm gear 321 for changing the rotary shaft as it is engaged with the spur gear 402, and a plane gear engaged with the gear teeth formed at the lower sides of the first main pulley 323 and the direction adjusting gear 322 is formed at a lower side of the worm gear 321. A plane gear is formed on a lower side of the second main pulley 323a and is engaged with the direction adjusting gear 322. The gears formed on the lower sides of the worm gear 321, the direction adjusting gear 322 and the first and second main pulleys 323 and 323a are engaged one another and rotate depending on the rotation of the worm gear 321. Here, the direction adjusting gear 322 has the same circumference as the worm gear 321 so that the angular speeds of the first and second main pulleys 323 and 323a are same. The first and second cooperation pulleys 324 and 324a are spaced apart from the first and second main pulleys 323 and 323a and are installed opposite to each other near the both sides of the main bracket 310, respectively.

The first and second belts 330 and 340 are inserted between the first and second main pulleys 323 and 323a and the first and second cooperation pulleys 324 and 324a, and the first belt 330 is supported by means of the first main pulley 323 and the first cooperation pulley 324 spaced apart from the first main pulley 323. So, as the worm gear 321 rotates, the first belt 330 rotates. The second belt 340 is supported between the second main pulley 323a and the second cooperation pulley 324a spaced apart from the second main pulley 323a. As the worm gear 321 rotates, the second belt 340 rotates in the reverse direction of the first belt 330. At this time, the first and second main pulleys 323 and 323a and the first and second cooperation pulleys 324 and 324a, which connect the first and second belts 330 and 340, respectively, are arranged so that the first and second belts 330 and 340 rotate in parallel at the both opposite sides of the main bracket 310.

The first and second cooperation pulleys 324 and 324a can be selectively constructed in the following two methods.

When the first main pulley 323 is installed at a corner of the main bracket 310, one end of the first belt 330 is supported by means of the first main pulley 323, and the other end of the same is supported by means of the first cooperation pulley 324. At this time, the first cooperation pulley 324 is installed in parallel with respect to the first main pulley 323 so that the outer side of the first belt 330 can be positioned on the parallel line with respect to the side surface of the main bracket 310.

In another construction, when the second main pulley 323a cannot be installed at a corner of the same, a second auxiliary pulley 325a is further provided at a corner of the main bracket 310 so that the second belt 340 can rotate in parallel with respect to the side surface of the main bracket 310.

An outer side of the second belt 340 is wound on the second auxiliary pulley 325a, and the second belt 324a, which passes through the second auxiliary pulley 325a and the second cooperation pulley 324a, is arranged in parallel with respect to the side surface of the main bracket 310.

A fourth auxiliary pulley 326a may be further installed at an inner side of the second auxiliary pulley 325a so as to utilize the space through which the second belt 340 wound on the second main pulley 323a and the second cooperation pulley 324a passes, and the inner side of the second belt 340 is engaged on the fourth auxiliary pulley 326a. A space 311 is formed in the above space for installing a driving device, a heat radiator for a screen driving device, etc.

The application of each auxiliary pulley is determined depending on the installation position of the driving force unit 400. As shown in FIG. 8, when the driving force unit 400 is inclined and installed at the corner of the main bracket 310, the first belt 330 is directly engaged with the first main pulley 323 and the first cooperation pulley 324, and the second belt 340 is engaged with the second main pulley 323a and the second cooperation pulley 324a. Second and fourth auxiliary pulleys 325a and 326 may be further provided at the intermediate portions of the same, respectively.

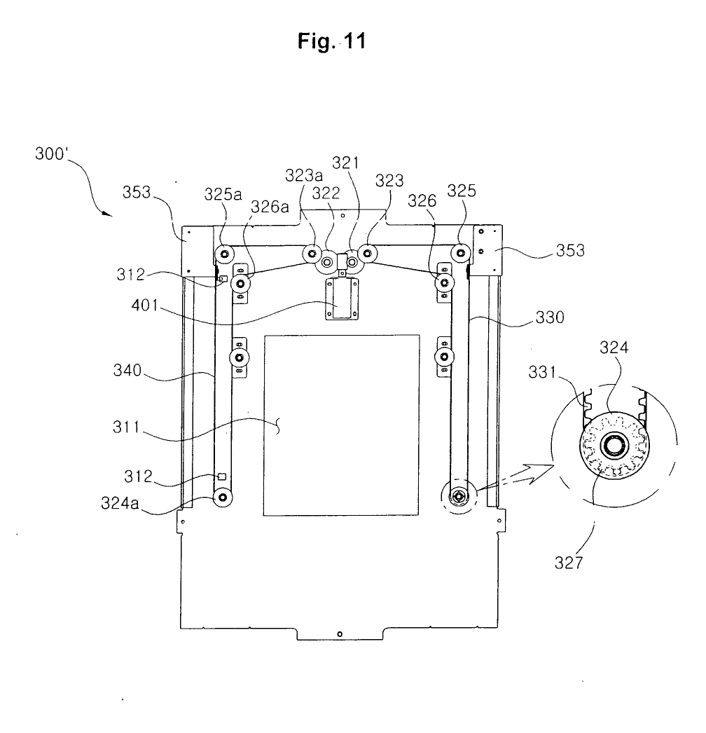

As shown in FIG. 11, when the driving force unit 400 is installed at the center of the lateral side of the main bracket 310, the intermediate portions of the first and second belts 330 and 340 may be supported by the first and second main pulleys 323 and 323a, the first and second auxiliary pulleys 325 and 325a installed at the corners except for the corners of the first and second cooperation pulleys 324 and 324a, and the third and fourth auxiliary pulleys 326 and 326a installed at the inner side of the same.

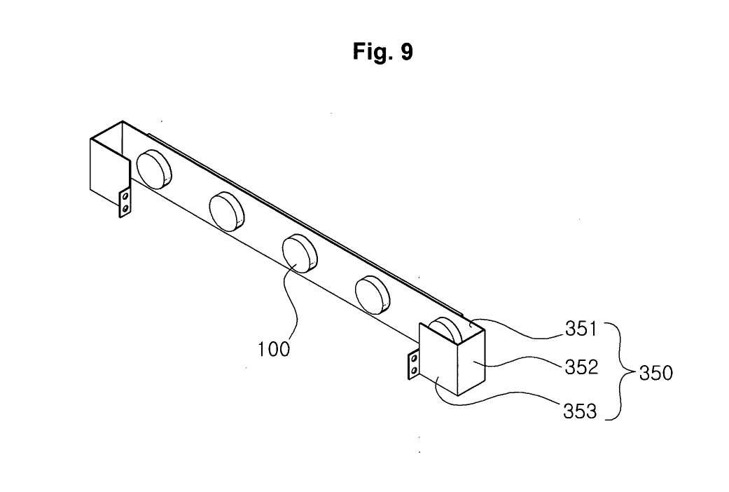

As shown in FIG. 9, the transportation bracket 350 comprises a front piece 351 in which at least one measurement sensor unit 100 is engaged at its inner side, a side piece 352 which is bent at and extended from the both longitudinal ends of the front piece 351 and surrounds the side surfaces of the screen 601 and the main bracket 310, and a back surface piece 353 which is bent at and extended from the side surface piece 352 and is supported by the first and second belts 330 and 340. The transportation bracket 350 is generally formed in a C-shape.

The side surface piece 352 has a certain length corresponding to the thickness including the screen and the driving apparatus of the screen so that the measurement sensor unit 100 fixed at the front surface piece 351 can slide while being spaced from the screen 601. So, the transportation bracket 350 surrounds the screen and the driving apparatus of the screen, and the measurement sensor unit 100 is transported while being spaced from the screen 601.

The constructions of the first and second belts 330 and 340 of FIG. 11 will be described.

Gear teeth 327 are formed on the outer surfaces of the first and second main pulleys 323 and 323a, or the first and second cooperation pulleys 324 and 324a or the first through fourth auxiliary pulleys 325, 325a, 326 and 326a, respectively, so that the transportation bracket 350 can be uniformly transported based on the rotations of the first and second belts 330 and 340, and teeth 331 engaged with the gear teeth can be formed at the inner sides of the first and second belts 330 and 340, respectively.

With the above constructions, the first and second belts 330 and 40 accurately rotate, without slip, with respect to the rotations of the first and second main pulleys 323 and 323a or the first and second cooperation pulleys 324 and 324a or the first through fourth auxiliary pulleys 325, 325a, 326 and 326a, respectively.

The first and second belts may be formed of a steel wires or the like. In this case, the height of each pulley can be decreased, and it is possible to make each corner of the video appliance thinner.

The position recognition sensor 312 of FIG. 11 will be described.

The position recognition sensor 213, which recognizes the position of the back surface piece 353, may be provided on the passage of the back surface piece 353 of the main bracket 310. The position recognition sensor 312 can be installed near the portion where the measurement sensor unit 100 is installed at the target point 602 of the screen 601, and the portion of the back surface piece 353 near the portion where the measurement sensor unit 100 is positioned at a side of the video appliance 600. So, it is possible to judge whether the measurement sensor unit 100 is positioned at the center of the screen 601 or is positioned at the side surface of the video appliance 600 in accordance with a signal from the position recognition sensor 312. At this time, the position recognition sensor 312 may be formed of a photo sensor like the earlier embodiment of the present invention.

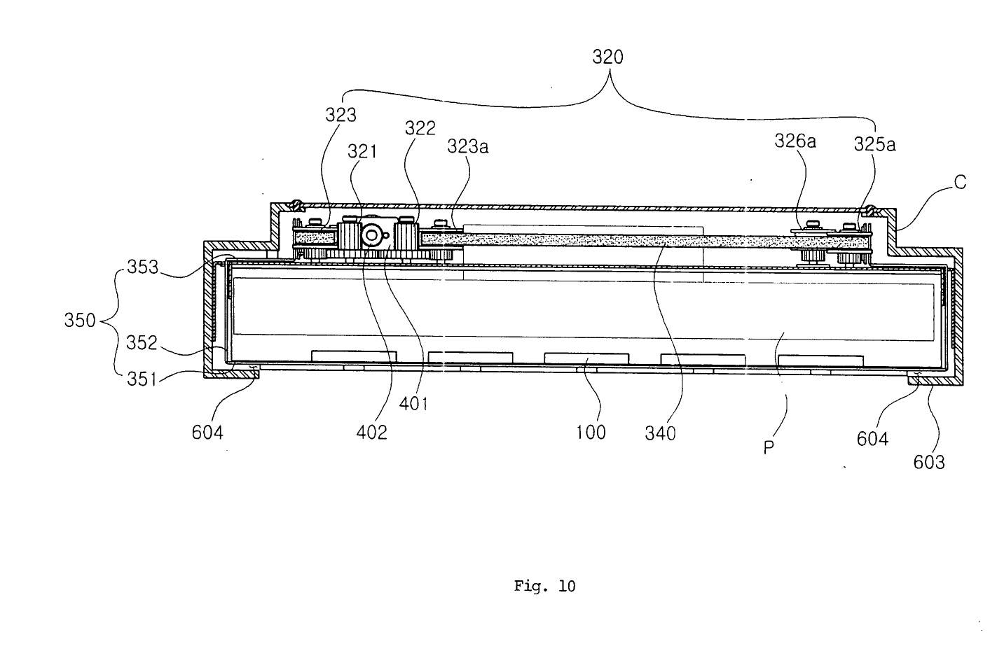

As shown in FIG. 10, a space groove 604 is formed between the rum of the video appliance casing C and the edge of the screen 601 (FIG. 5) of the video appliance 600 (FIG. 5), so the front piece 351 and the side piece 352 of the transportation bracket 350 can slide therein. In addition, when the characteristic value of the screen is not measured, the transportation bracket 350 may be accommodated in the space groove 604.

The operation of the transportation unit 300 according to another embodiment of the present invention will be described.

When the characteristic values of the video appliance are not measured, the transportation bracket 350 is positioned at one side of the main bracket 310. When viewing from the outside of the video appliance 600, the transportation bracket 350 is accommodated between the rims 603 which surround the edges of the screen 601, so the construction looks good.

When measuring the characteristic values of the video appliance, the spur gear 402 rotates depending on the rotation of the motor 401 of the driving force unit 400. The first and second belts 330 and 340 rotate in different directions depending on the rotation of the driving force transfer unit 320. The transportation bracket 350 is transported to the center of the screen 601 by means of the back surface piece 353 engaged to the first and second belts 330 and 340. When viewing from the outside of the video appliance 600, the front surface of the transportation bracket 350 slides along the rim 603 of one side of the video appliance 600.

After the characteristic values of the video appliance are measured, the transportation bracket 350 returns to its original position by reversely changing the rotation direction of the motor 401 of the driving force unit 400.

At this time, in case that the position recognition sensor 312 is disposed, when the transportation bracket 350 is positioned at the center of the screen 601, the position recognition sensor 312 recognizes the position of the back surface piece 353 and stops the operation of the driving force unit 400. It recognizes the position of the back surface piece 353 when the transportation bracket 350 is fully accommodated, and stops the operation of the driving force unit 400 as the transportation bracket 350 returns to its original position.

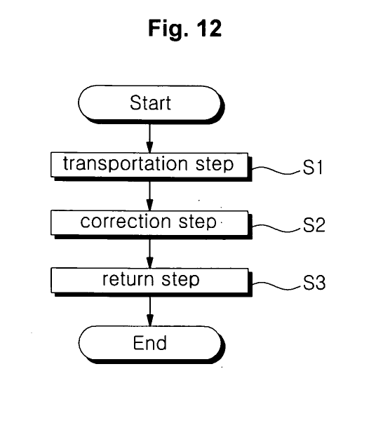

The automatic transportation method of a measurement sensor unit for measuring the characteristic values of a video appliance according to the present invention will be described with reference to FIG. 12.

In a transportation method of a measurement sensor unit by using an automatic transportation apparatus of a characteristic value measurement sensor unit of a video appliance which includes a measurement sensor unit 100, transportation unit 200 and 300, a driving force unit 400 and a controller unit 500, there is provided an automatic transportation method of a characteristic value measurement sensor unit of a video appliance which comprises a transportation step in which the measurement sensor unit 100 is positioned near the center of the screen of the video appliance 600 as the driving force unit 400 operates depending on a measurement start instruction of a user; a correction step in which a characteristic value of a video appliance is measured by using the measurement sensor unit 100, and the screen is adjusted by using the measured video appliance characteristic value; and a return step in which the measurement sensor unit 100 returns to its original position by operating the driving force unit 400 after the screen adjustment is finished.

In the transportation step, when there is a measurement start instruction from an input unit, the controller unit 500 recognizes the input, and operates the driving force unit 400 for transporting the measurement sensor unit 100 engaged to the transportation units 200 and 300 to near the center of the screen in a step S1.

At this time, when the measurement sensor unit 100 is positioned near the center of the screen, the motor 401 is stopped in the following method.

The controller unit 500 may allow the spur gear 402 by the rotations previously set depending on the specs of the spur gear 402 engaged to the transportation units 200 and 300 and the rack gears 211b and 221b.

In another example, a certain rotational road may be applied to the motor 401 as the first and second engaging pieces 212 and 222 are engaged with the second auxiliary engaging surface 262 by using the structural operation limits of the transportation units 200 and 200, and the controller unit 500 recognizes the rotational load for thereby disconnecting the power supply of the driving force unit 400.

When the position recognition sensors 253 and 312 generate signals by recognizing the position of the first transportation piece 211 or the second transportation piece 221 or by recognizing the position of the back surface piece 353 of the transportation bracket 350, the controller unit 500 receives the signals and disconnects the power supply of the driving force unit 400.

In the correction step, the characteristic value of the video appliance is corrected based on the known program by using the characteristic values of the video appliance measured in the sensor measurement unit in a step S2.

In the returning step, the controller unit 500 checks the completion of the measurement of the characteristic value of the video appliance from a signal from the measurement sensor unit 100 or a corresponding program and allows the measurement sensor unit 100 to return to its original position by rotating the motor 401 in the direction reverse to the rotation direction of the transportation step in a step S3.

At this time, when the measurement sensor unit 100 is returned, the motor 401 is stopped in the following methods. Namely, the motor can be stopped by using a method which uses the set revolutions of the spur gear 402, or a method which uses a rotational load generating as the lengths of the first and second transportation grooves 211a and 221a are limited, and a method which is implemented by installing a position recognition sensor in the first transportation groove 211a or by installing a position recognition sensor near a corner of the main bracket 310.

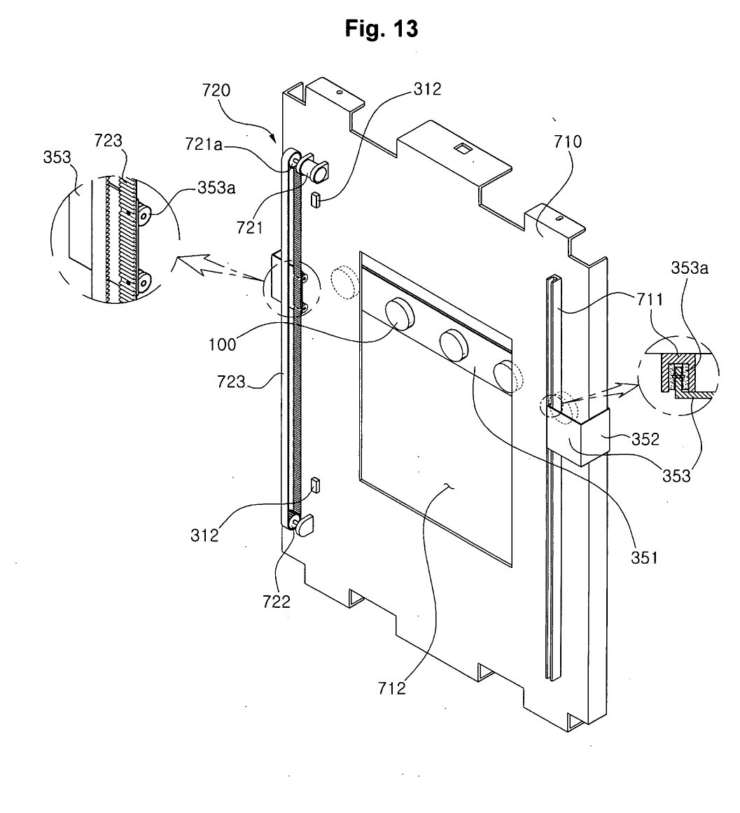

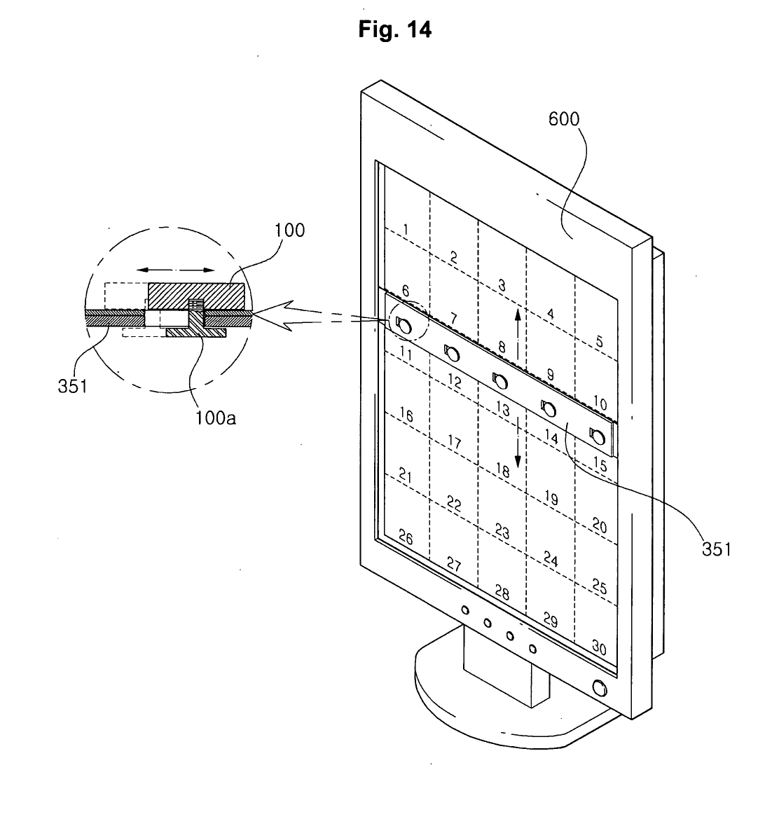

FIG. 13 is a perspective view illustrating an automatic transportation apparatus of a measurement sensor for measuring the characteristic values of a video appliance according to another embodiment of the present invention, and FIG. 14 is a view illustrating a use state of an automatic transportation apparatus of a measurement sensor unit for measuring the characteristic values of a video appliance of FIG. 13.

The automatic transportation apparatus 700 of the measurement sensor unit for measuring the characteristic values of the video appliance according to another embodiment of the present invention comprises a main bracket 710, a driving motor unit 720, a transportation bracket 350, and a controller unit 500. Here, the same elements are given the same reference numerals.

The main bracket 710 is installed at one side of the video appliance 600, and as shown in FIG. 13 is formed in a rectangular shape. The upper and lower sides of the same are bent and supported by the video appliance 600. A guide rail 711 is installed at one side of the main bracket 710 for supporting one side of the transportation bracket 350. A space 712 is formed at the center of the main bracket 710 and operates with the same functions as described earlier. The position recognition sensor 312 is installed in the main bracket 710.

The driving motor unit 720 moves the transportation bracket 350, which will be described later. As shown in FIG. 13, the driving motor unit 720 is installed at one side of the main bracket 710. In more detail, the driving motor unit 720 comprises a driving motor 721 which is engaged with a spur gear 721a at its one side, and is installed on an upper side of the main bracket 710, a pulley 722 which is spaced apart from the driving motor 721 and is installed at a lower side of the main bracket 710, and a connection member 723 which connects the spur gear 721a and the pulley 722. The connection member is preferably formed of a belt of which a rack is formed at its one side.

The transportation bracket 350 comprises a front surface piece 351, a side surface piece 352, and a back surface piece 353. As shown in FIG. 13, the connection member 722 is fixed in the back surface piece 353 of one side, and the back surface piece 353 of the other side is supported by means of the guide rail 711.

As shown in FIG. 13, at least one measurement sensor unit 100 is installed in the transportation bracket 350 for efficiently measuring the screen of the video appliance 600. As shown in FIG. 14, with the above constructions, it is possible to divide the area of the LCD monitor into smaller areas. Each divided area is assumed as one sector. 30 values are measured with respect to the brightness of each divided sector as the five measurement sensor units 100 move while measuring. As shown in FIG. 14, when the measurement sensor unit 100 is engaged to the transportation bracket 350, a longitudinal hole (not shown) is formed in the front surface piece 351, the measurement sensor unit 100 may be thread-engaged with a handle 100a for a movement in the longitudinal hole in left and right directions. This construction can be adapted in the same manner in the earlier embodiments of the present invention.

As shown in FIG. 13, a roller 353a is engaged at an end of the back surface piece 353 of the transportation bracket 350. With the above simple construction, it is possible to decrease the friction between the transportation bracket 350 and the min bracket 710, so that it is possible to smoothly move the transportation bracket 350.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In an automatic transportation apparatus of a measurement sensor unit for measuring a characteristic value of a video appliance, an automatic transportation apparatus of a characteristic value measurement sensor unit of a video appliance, comprising:
a driving force unit which has a driving motor engaged with a spur gear at one side of the same;
a transportation unit which is installed at one side of the video appliance and allows the measurement sensor unit engaged to one side to be connected with the spur gear when measuring a characteristic value of the video appliance and to be positioned at the center of the screen of the video appliance and to return to its original position after the measurement is finished; and
a controller unit which controls the driving force unit.

2. The apparatus of claim 1, wherein said transportation unit comprises:
a first guide bracket which includes a first transportation piece having a first transportation groove in which a rack gear tooth-engaged with the spur gear is longitudinally formed in an inner surface, and a first engaging piece which is extended from the first transportation piece, with its end being bent toward the screen;
a second guide bracket which slide in contact with the first guide bracket and includes a second transportation groove in which a rack gear tooth-engaged with the spur gear of the motor is formed in a direction reverse to the formation position of the rack gear of the first transportation groove, and a second engaging piece which is extended from the second transportation piece, with its end being bent toward the screen; and
first and second rotation brackets which fix the measurement sensor unit with one end of each of the first and second rotation brackets being rotatably engaged to the first and second engaging pieces, respectively, and with the other ends of the first and second rotation brackets being rotatably engaged with each other.

3. The apparatus of claim 2, wherein said transportation unit comprises:
a first cover bracket which has a longitudinal first guide groove to which a protrusion protruded from the first transportation piece is slide-engaged, and which is engaged to an outer side of the first guide bracket; and
a second cover bracket which is engaged with the first cover bracket at an outer side of the second guide bracket and has a second guide groove in which a protrusion protruded from the second transportation piece is slide-engaged, whereby the second cover bracket is fixed to the first cover bracket.

4. The apparatus of claim 3, wherein a support piece is disposed between the first and second engaging pieces and the screen and is bent toward the screen so that the first and second engaging pieces can slide while being spaced apart from the screen, and a pad bracket is further disposed between the first guide bracket and the first cover bracket or between the second guide bracket and the second cover bracket.

5. The apparatus of claim 2, wherein said engaged portions of the first and second rotation brackets are rotatably engaged on a first engaging surface extended from a longitudinal end portion of the first rotation bracket in a direction of the first guide bracket, and are rotatably engaged on a second engaging surface which is bent along the first engaging surface at a longitudinal end portion of the second rotation bracket, and the measurement sensor unit is engaged at a longitudinal end portion of the first rotation bracket.

6. The apparatus of claim 3, wherein a position recognition sensor is installed in either the first cover bracket or the second cover bracket for recognizing the slid position of the first transportation piece or the second transportation piece, with the position recognition sensor being engaged at one side of the first guide groove or the second guide groove.

7. The apparatus of claim 1, wherein said transportation unit comprises:
a main bracket for fixing the driving force unit therein;
a driving force transfer unit which includes a worm gear tooth-engaged to a spur gear of the driving force unit, a first main pulley engaged to the worm gear, a second main pulley which is connected with the worm gear, with a direction adjusting gear being disposed at the same so that the second main pulley can rotate in the direction reverse to the rotation direction of the first main pulley, and an auxiliary pulley which is fixedly spaced apart from the first and second main pulleys, respectively;
first and second belts which are parallel with respect to the both opposite sides of the main bracket, with one end of each of the first and second belts being supported by means of the first and second main pulleys, respectively, and the other end of each of the same being supported by the first and second cooperation pulleys, respectively; and
a transportation bracket which includes a front surface piece in which at least one measurement sensor unit is engaged, a side surface piece which is bent from the both longitudinal ends of the front surface piece and surrounds the side surfaces of the screen and the main bracket, respectively, and a back surface piece which is bent and extended from the side surface piece and is fixed along with the first and second belts, respectively.

8. The apparatus of claim 7, wherein the outer sides of said first and second belts are supported by the first and second auxiliary pulleys, respectively, which are spaced apart from the first and second cooperation pulleys on a parallel plane with respect to one side surface of the main bracket.

9. The apparatus of claim 8, wherein the inner sides of said first and second belts are supported by the third and fourth auxiliary pulleys which are installed at the more inner sides as compared to the first and second auxiliary pulleys.

10. The apparatus of claim 7, wherein gear teeth are formed on the outer surfaces of the first and second main pulleys or the first and second cooperation pulleys or the first through fourth auxiliary pulleys, and teeth engaged with the gear teeth are formed in the inner sides of the first and second belts, respectively.

11. The apparatus of claim 7, wherein said first and second belts are formed of steel wires, respectively.

12. The apparatus of claim 1, wherein a position recognition sensor is provided in the main bracket for recognizing the position of the back surface piece.

13. The apparatus of claim 7, wherein said transportation bracket of the transportation unit is accommodated in the space groove formed between the video appliance and the casing of the video appliance.

14. In an automatic transportation apparatus of a characteristic value measurement sensor unit of a video appliance, an automatic transportation apparatus of a characteristic value measurement sensor unit of a video appliance, comprising:
a main bracket which is installed in the video appliance with a guide rail being fixed at one side of the main bracket;
a driving motor unit which includes a driving motor installed in the main bracket and engaged with a spur gear at its one side, a pulley which is spaced apart from the driving motor and is installed in the main bracket, and a connection member which connects the spur gear and the pulley, respectively;
a transportation bracket in which at least one measurement sensor unit is engaged at one side of the transportation bracket with one end of the transportation bracket being fixed to the connection member, and with the other end of the same being supported by means of the guide rail; and
a controller unit which controls the driving motor.

15. The apparatus of claim 1, wherein a roller is installed at an end of the transportation bracket.

16. The apparatus of either claim 14, wherein a space part is formed in one side of the main bracket.

17. In a transportation method of a measurement sensor unit by using an automatic transportation apparatus of a characteristic value measurement sensor unit of a video appliance which includes a measurement sensor unit, a transportation unit, a driving force unit and a controller unit, an automatic transportation method of a characteristic value measurement sensor unit of a video appliance, comprising:
a transportation step in which the measurement sensor unit is positioned near the center of the screen of the video appliance as the driving force unit operates depending on a measurement start instruction of a user;
a correction step in which a characteristic value of a video appliance is measured by using the measurement sensor unit, and the screen is adjusted by using the measured video appliance characteristic value; and
a return step in which the measurement sensor unit returns to its original position by operating the driving force unit after the screen adjustment is finished.

18. The method of claim 17, wherein in said transportation step or said return step, the motor engaged in the driving force unit is rotated by the previously set revolutions, so that the measurement sensor unit is transported to near the center of the screen, or returns to its original position.

19. The method of claim 17, wherein in said transportation step or said return step, the controller unit recognizes a rotation load generating in the motor engaged in the driving force unit depending a displacement limit of the transportation unit and disconnects the power supply to the driving force unit and finishes the operational routine.

20. The method of claim 17, wherein in said transportation step or said return step, the controller unit receives a signal from the position recognition sensor engaged in the transportation unit and disconnects the power supply to the driving force unit and finishes the operational routine.
